(19) United States
(12) Patent Application Publication
(10) Pub. No.: US 2014/0089239 A1
(43) Pub. Date: Mar. 27, 2014

(54) Methods, Apparatuses and Computer Program Products for Providing Topic Model with Wording Preferences

(71) Applicant: Nokia Corporation, Espoo (FI)

(72) Inventors: Rile Hu, Beijing (CN); Wenfeng Li, Beijing (CN); Jilei Tian, Beijing (CN); Xiaojie Wang, Beijing (CN)

(21) Appl. No.: 14/116,170

(22) PCT Filed: May 10, 2011
(86) PCT No.: PCT/CN2011/073902

§ 371 Date: Nov. 7, 2013

(51) Int. Cl. G06N 99/00

(52) U.S. Cl. CPC G06N 99/005
USPC 706/12

(57) ABSTRACT

An apparatus for determining one more preferred words of a user may include a processor and memory storing executable computer program code that cause the apparatus to at least perform operations including implementing a topic model including data associated with one or more word preferences of at least one user. The computer program code may further cause the apparatus to implement a training model of the topic model to generate the word preferences based in part on analyzing training data of the training model. The training data including content associated with one or more determined topics. The computer program code may further cause the apparatus to determine that the word preferences correspond to one or more preferred words of respective users. Corresponding methods and computer program products are also provided.

### TECHNOLOGICAL FIELD

An example embodiment of the invention relates generally to topic modeling, and more particularly, relates to a method, apparatus, and computer program product for facilitating an efficient and reliable manner in which to generate wording preferences based in part on utilizing the topic model.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal.

One such service may involve identifying topics in one or more documents and providing word suggestions to a user based on the identified topics. In this regard, topic modeling is typically a type of statistical model for discovering the topics that occur in a collection of documents. At present, a topic model may model documents as a mixture of topics and each topic may be represented by words. Although topics may be identified from documents, wording preferences of an author of all or a portion of the document are typically not considered. A wording preference may relate to the notion that different people generally use different words even when talking about the same topic. Current modeling approaches typically do not take the wording preferences of users into account.

In this regard, current topic model approaches typically presume that each word objectively represents the topics of a document. For instance, existing topic models typically presume that the same word is the same for different users when expressed about the same topic. However, in reality each word of the document typically relates to the subjective expression of the user. For instance, for the same topic, different users may use different kinds of words when discussing the same topic(s) based on the word preferences of the users.

Additionally, existing topic models typically need to know the number of topics of a document at the beginning of a training procedure utilized for training the topic models. However, this may have a drawback of making the topic model inflexible and difficult to determine the topics.

As such, it may be beneficial to provide a mechanism for enabling provision of a topic model that accounts for the wording preferences of different users or authors and which may not need to know the number of topics prior to training of the topic model.

### BRIEF SUMMARY

A method, apparatus and computer program product are therefore provided for enabling provision of an efficient and reliable topic model that may determine one or more word preferences of a user(s). In an example embodiment, one or more of the determined word preferences may be provided to a display of an apparatus for selection by a corresponding user. In this regard, an example embodiment may provide an improved topic model by taking personal wording preferences of one or more users into account. Additionally, an example embodiment may generate one or more personal wording preferences or profiles such that the wording preferences/profiles may be utilized for a personalized application(s) and/or service(s). In addition, an example embodiment may be beneficial, for example, in minimizing a perplexity of a topic model of an embodiment of the invention.

An example embodiment of the invention may determine that tagged words are often associated with topics included in within a document(s). In this regard, a device of an example embodiment may determine that users with different preferences of using words tend to use different words to represent the same topic. In this regard, an example embodiment may determine one or more wording preferences of different users to gain insight about the users. Based in part on the determined wording preferences of the different users, an example embodiment of the invention may recommend one or more personalized tags (e.g., suggested preferred words) to a corresponding user for selection. In response to receipt of an indication of a selection of a personalized tag, an example embodiment may include data (e.g., a suggested word(s)) associated with the personalized tag in another tag or comment of the corresponding user. In this regard, an example embodiment may provide an easier, reliable and more efficient manner in which to enable a user to generate tags, associated with a topic, within a document(s).

In one example embodiment, a method for determining one or more preferred words of a user(s) is provided. The method may include implementing a topic model including data associated with one or more word preferences of at least one user. The method may further include implementing a training model of the topic model to generate the word preferences based in part on analyzing training data of the training model. The training data may include content associated with one or more determined topics. The method may further include determining that the word preferences correspond to one or more preferred words of respective users.

In another example embodiment, an apparatus for determining one or more preferred words of a user(s) is provided. The apparatus may include a processor and memory including computer program code. The memory and the computer program code are configured to, with the processor, cause the apparatus to at least perform operations including implementing a topic model including data associated with one or more word preferences of at least one user. The computer program code may further cause the apparatus to implement a training model of the topic model to generate the word preferences based in part on analyzing training data of the training model. The training data includes content associated with one or more determined topics. The computer program code may further cause the apparatus to determine that the word preferences correspond to one or more preferred words of respective users.

An embodiment of the invention may provide a better user experience since the user may be provided with one or more words based on the user's preferences. As a result, device users may enjoy improved capabilities with respect to applications and services accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic diagram illustrating a graphical model for generating wording preferences according to an example embodiment of the invention;

FIG. 4 is a diagram illustrating a topic model with wording preferences according to an example embodiment of the invention;

FIG. 5 is a diagram illustrating a Gibb sampling inference procedure according to an example embodiment of the invention;

FIG. 6 illustrates a flowchart for generating one or more word preferences for proposed selection according to an example embodiment of the invention; and

FIG. 7 illustrates a flowchart for generating one or more word preferences of one or more users according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein a “document,” “document(s)” and similar terms may be used interchangeably and may refer to and/or may include a written or printed publication or paper (e.g., a digital publication(s), digital paper(s)), an image(s), a recording(s), a photograph(s), a video(s), text data, a file(s), a file system(s) and any other suitable mechanism or media including, storing and/or communicating information. In one example embodiment, a document(s) may, but need not, correspond to data associated with a Uniform Resource Locator (URL) or content of a web page(s).

As referred to herein, a “tag,” “tag(s),” “tagged data” and similar terms may be used interchangeably to refer to data, including but not limited to, a keyword(s), a term(s) or the like assigned to a piece or item of information (e.g., metadata) such as, for example, an Internet bookmark, digital image, digital picture, video, computer file, etc.). The metadata of a tag(s) may describe an item(s) and may allow the item and/or the tag(s) to be found by browsing, searching or the like. The tag(s) may, but need not, be chosen by a creator(s) (e.g., an author(s)) of an item(s), by a device or in any other suitable manner.

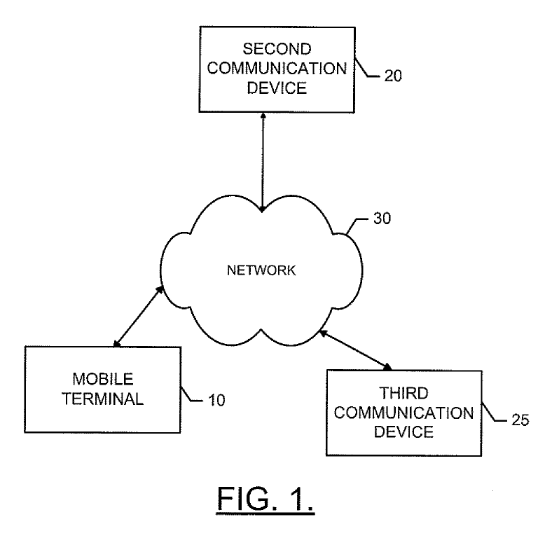

FIG. 1 illustrates a generic system diagram in which a device such as a mobile terminal 10 is shown in an exemplary communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the invention may further include one or more additional communication devices, one of which is depicted in FIG. 1 as a third communication device 25. In one embodiment, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the invention. Furthermore, devices that are not mobile, such as servers and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (FDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as, for example, personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

As such, in one embodiment, the mobile terminal 10 may itself perform an example embodiment. In another embodiment, the second and third communication devices 20 and 25 may facilitate operation of an example embodiment at another device (e.g., the mobile terminal 10). In still one other example embodiment, the second communication device 20 and the third communication device 25 may not be included at all.

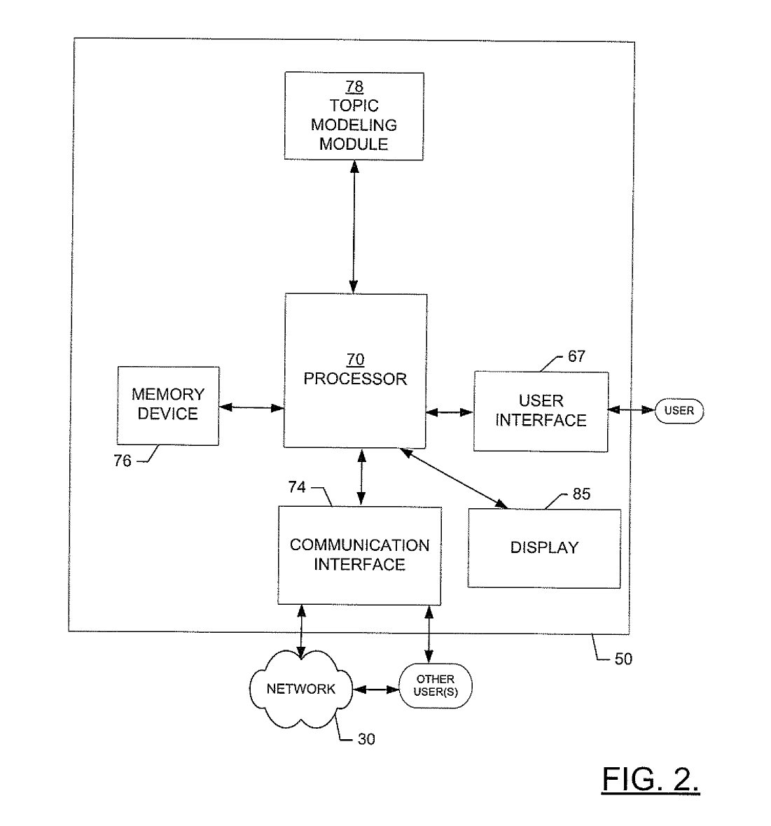

In another example embodiment, the mobile terminal as well as the second and third communication devices 20 and 25 may employ an apparatus (e.g., apparatus of FIG. 2) capable of employing some embodiments of the invention.

FIG. 2 illustrates a schematic block diagram of an apparatus for determining one or more word preferences of a user for selection. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, and a topic modeling (TM) module 78. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., images, pictures, videos, etc.). The memory device 76 may also store one or more documents as well as one or more Uniform Resource Locators (URLs) and any other suitable data.

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, and/or a coprocessor that may execute a browser or the like. In this regard, the connectivity program may enable the apparatus 50 to transmit and receive Web content, such as for example location-based content, or any other suitable content, according to a Wireless Application Protocol (WAP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the TM module 78. The TM module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the TM module 78, as described below. Thus, in an example in which software is employed, a device or circuitry (e.g., the processor 70 in one example) executing the software forms the structure associated with such means.

The TM module 78 may utilize a topic model that has or includes a training procedure/model for predicting one or more topics of a document(s). The training model may also be used/implemented by the TM module 78 to determine or predict one or more tags (e.g., words (e.g., preferred words)) of a document(s). The TM module 78 may utilize/implement the topic model to generate one or more personal wording preferences (also referred to herein as word preferences) of one or more users.

By utilizing/implementing the topic model of an example embodiment, the tags of a document(s) may be mapped, by the TM module 78 to one or more topics dimensionality and the tags (e.g., comments) and one or more users creating the tags may be mapped, by the TM module 78, to one or more wording preferences dimensionality. Since the topics and the wording preferences may both be mapped dimensionally and connected or linked to the tags, the TM module 78 may utilize this information to determine a relationship between users from a wording preference perspective and tags from a topic perspective.

For an example in which the manner of the relationship between different users from a wording preference perspective and tags from a topic perspective may be determined by the TM module 78, consider, for purposes of illustration and not of limitation, an example in which a document(s) (e.g., URL 1) may include tag A and tag B of user A and another document(s) (e.g., URL 2) that may include tag C and tag E of user B and tag D and tag F of User C. In this example, the tags (e.g., tag A, tag B, tag C, tag D, tag E and tag F) may, but need not, relate to one or more comments of the respective users within the respective documents. (e.g., URL 1, URL 2)

By utilizing the data associated with the documents (e.g., URL 1, URL 2), the TM module 78 may train the topic model of an example embodiment and may obtain the following results in this example:

URL 1: topic A 10%, topicB 70%, topicC 20%
URL 2: topic A 60%, topicB 15%, topicC 25%
Relationship of Tags from Topic Perspective
topic A: tag A 10%, tag B 15%, tag C 20%, tag D 30%, tag E 10%, tag F 15%
topic B: tag A 10%, tag B 35%, tag C 20%, tag D 20%, tag E 10%, tag F 5%
topic C: tag A 15%, tag B 15%, tag C 20%, tag D 25%, tag E 20%, tag F 5%

### Relationship Between Different Users and Wording Preference

user A: Wording Preference A 20%, WordingPreferenceB 80%
user B: Wording Preference A 50%, WordingPreferenceB 50%
user C: Wording Preference A 80%, WordingPreferenceB 20%
Wording Preference A: user A 20%, userB 30%, userC 50%
Wording Preference B: user A 40%, userB 40%, userC 20%
Wording Preference C: user A 35%, userB 50%, userC 15%

### Wording Preference A:

topic A:: tag A 10%, tag B 15%, tag C 20%, tag D 30%, tag E 10%, tag F 15%
topic B:: tag A 20%, tag B 5%, tag C 20%, tag D 10%, tag E 30%, tag F 15%
topic C:: tag A 20%, tag B 15%, tag C 10%, tag D 30%, tag E 20%, tag F 5%

### Wording Preference B:

topic A:: tag A 10%, tag B 15%, tag C20%, tag D 30%, tag E 10%, tag F 15%
topic B:: tag A 40%, tag B 5%, tag C10%, tag D 10%, tag E 20%, tag F 15%
topic C:: tag A 30%, tag B 25%, tag C10%, tag D 20%, tag E 10%, tag F 5%

### Wording Preference C:

topic A:: tag A 5%, tag B 20%, tag C 20%, tag D 30%, tag E 10%, tag F 15%
topic B:: tag A 50%, tag B 5%, tag C 10%, tag D 10%, tag E 20%, tag F 5%
topic C:: tag A 25%, tag B 10%, tag C 5%, tag D 30%, tag E 25%, tag F 5%

As such, the TM module 78 may map the tags and users to topics and wording preferences and may utilize this mapped information to recommend personalized tags (e.g., suggested or recommended preferred words) to different users based on the wording preferences of respective users.

In an example embodiment, the wording preference(s) generated by the TM module 78, utilizing/implementing the topic model, may be static after applying the training model. In one example embodiment, the TM module 78 may implement an algorithm (e.g., a batched inference algorithm) to generate a topic model that is static. In one example embodiment, a topic model that is static may denote a topic model that may not automatically change after a training model is applied to the topic model by the TM module 78. In an alternative example embodiment, the TM module 78 may enable the wording preference(s) to evolve gradually during usage of the topic model over time. In this example embodiment, the TM module 78 may implement an algorithm (e.g., an online inference algorithm) to utilize newly obtained data relating to one or more identified tags of one or more users within a document(s). These identified tags may be utilized by the TM module 78 to train the topic model over time.

For purposes of illustration and not of limitation regarding the manner in which the TM module 78 may utilize newly obtained data to train the topic model of an example embodiment, consider an example in which a document such as, for example, web content of a URL (e.g., URL 3) may include new data obtained/received such as, for example, tag C and tag D of user B and tag D and tag F of user C. In this regard, the TM module 78 may analyze and detect the data (e.g., new data) of the URL to determine or estimate the topic distribution of the URL (e.g., URL 3: topic A 10%, topic B 55%, topic C 35%, etc.) and then based on this estimation/determination of the topic distribution, the TM module 78 may estimate/determine: (1) another user (e.g., user A) that may be interested in data (e.g., web content) of the URL 3 since the topic model utilized/implemented by the TM module 78 may have knowledge of the data associated with other URLs of interest to this user (user A); (2) the tags of URL 3 (for e.g., user A may mark or input data such as for example, tag A and tag B in the web content of URL 3, and the TM module 78 may detect these tags); and/or (3) which user generated tag A and tag B in the web content of URL 3, in an instance in which the TM module 78 may know tag A and tag B is generated by an known user (e.g., the TM module 78 may determine that user A generated the tag A and tag B). Additionally, the TM module 78 may perform any other suitable determinations/estimations.

In one example embodiment, the TM module 78 may utilize one or more wording preferences of one or more users to generate one or more respective user profiles. In one embodiment, the TM module 78 may, but need not, group the user profiles. The user profiles may be utilized by the TM module 78 to optimize/customize the topic model. For example, the TM module 78 may generate the user profiles to include a personalized description associated with respective users. The personalized description may be utilized by the TM module 78 to provide one or more recommendations (e.g., recommendations for a URL, recommended tag(s) (e.g., a recommended word(s), etc.), predictions (e.g., a prediction of one or more items of text without an identified author (e.g., a chapter of a book without an identified author), a prediction of an author, etc.) or any other suitable data.

For purposes of illustration and not of limitation, consider an example in which the TM module 78 may examine data of a profile for user C to determine preferences (e.g., one or more preferred tags (e.g., one or more preferred words of user C)) of user C. In this example embodiment, the TM module 78 may determine that there is data in the profile of user C including, but not limited to, Wording Preference A, Wording Preference B, topic A, topic B, topic C, tag A, tag B, tag C, tag D, tag E and tag F. In this regard, some of the data of the profile for user C is set forth below.

user C: Wording Preference A 80%, Wording Preference B 20%

### Wording Preference A:

topic A:: tag A 10%, tag B 15%, tag C 20%, tag D 30%, tag E 10%, tag F 15%
topic B:: tag A 20%, tag B 5%, tag C 20%, tag D 10%, tag E 30%, tag F 15%
topic C:: tag A 20%, tag B 15%, tag C 10%, tag D 30%, tag E 20%, tag F 5%

### Wording Preference B:

topic A:: tag A 10%, tag B 15%, tag C20%, tag D 30%, tag E 10%, tag F 15%
topic B:: tag A 40%, tag B 5%, tag C10%, tag D 10%, tag E 20%, tag F 15%
topic C:: tag A 30%, tag B 25%, tag C10%, tag D 20%, tag E 10%, tag F

In this example embodiment, in an instance in which the TM module 78 may analyze the data of the profile of user C, the TM module 78 may, but need not, determine that user C prefers to use tag C (e.g., a preferred word(s)) rather than or opposed to tag A (e.g., another preferred word(s)) to express topic B (e.g., a particular subject (e.g., sports, restaurants)), for example.

In one example embodiment, the TM module 78 may analyze one or more tagged words in a document(s) (e.g., a digital publication(s)) to determine a topic(s) corresponding to one or more of the tagged words. Additionally, the TM module 78 may determine different word preferences of different users based in part on analyzing data of the tagged words and may suggest or recommend one or more of the preferred words to a user(s) of an apparatus 50, as described more fully below.

In this regard, in an example embodiment the TM module 78 may consider or analyze one or more word preferences of a user(s) on top of a topic model in order to achieve better performance and to also obtain different user's wording preference to gain insight of the user and user profiling.

By utilizing the TM module 78, the apparatus 50 may provide one or more suggestions or recommendations in an instance in which one or more users desire to tag some data. For instance, in one example embodiment, the TM module 78 may provide one or more word recommendations to a user(s) of an apparatus 50. In this regard, the TM module 78 may obtain one or more word preferences of corresponding users for each topic in which the users may provide comments. In an instance in which a user may provide one or more new comments about a corresponding topic (e.g., sports), the TM module 78 may provide one or more recommendations for words that a corresponding user may utilize. The word recommendations, generated by the TM module 78, may be based on one or more word preferences of the corresponding user. The TM module 78 may enable the display 85 to show the word recommendations to the corresponding user for selection. By providing the word recommendations, the TM module 78 may make it easier for the user to input comments to a document(s). For example, the TM module 78 may enable one or more word recommendations to be presented via the display 85 for selection by a user and in response to receipt of an indication of a selection of at least one of the word recommendations, the selected word recommendation may be included in one or more comments (e.g., a sentence(s)) of the user within a corresponding document(s).

For purposes of illustration and not of limitation, consider an example in which a user may utilize an apparatus 50 to access a URL for providing comments. In this example embodiment, the user may utilize the apparatus 50 to access a URL such as, for example, http://www.nba.com/rockets/index_main.html associated with the Houston Rockets™. In this regard, the user may utilize the user interface 67 to incorporate one or more tags into a portion of data (e.g., a blog) of a web page associated with the http://www.nba.com/rockets/index_main.html URL. Presume for example, that the user may utilize the user interface 67 (e.g. keyboard) to generate comments about a basketball game in which a player such as, for example, Yao Ming played. In this regard, the user may utilize the apparatus 50 to post comments or tags to the web page such as for example, “I love the way Yao Ming played in the Rockets win over the Mavericks” and/or “I really liked Yao Ming's performance”. In this example, the TM module 78 may determine a topic of the URL. For instance, the TM module 78 may analyze data of the http://www.nba.com/rockets/index_main.html URL and may determine that a topic of the URL relates to basketball.

Additionally, the TM module 78 may analyze the tags of the user to determine one or more topics. In this example, the TM module 78 may determine that a topic(s) associated with the tag (e.g., “I love the way Yao Ming played in the Rockets™ win over the Mavericks™”, “I really liked Yao Ming's performance”) of the user may relate to the user's fondness of Yao Ming. As such, the TM module 78 may analyze data of the tags and may determine one or more words preferred by the user in describing Yao Ming. In this example, the TM module 78 may determine that the user preferred to use words such as, for example, “like” and “love” when describing the user's fondness of Yao Ming's game play. In this manner, in an instance in which the user may utilize the user interface 67 of the apparatus 50 to post another comment(s) about Yao Ming's performance, the TM module 78 may recommend to the user that the user utilize a preferred word(s) such as, for example, “like” or “love”. For instance, in an instance in which the user may provide additional comments (e.g., tags) about Yao Ming's performance, the TM module 78 may provide one or more word recommendations to the user via the display 85 based in part on the word preferences of the user. Upon receipt of a selection of a word recommendation (e.g., the word “love”), the TM module 78 may include the word recommendation in a comment/tag of the user (e.g., “I am going to ‘love’ when Yao Ming's hits 30 points against the Spurs™ next week”) associated with the same determined topic (e.g., fondness of Yao Ming's game play).

In another example, the TM module 78 may determine that a different user preferred to utilize different words associated with the same topic (e.g., fondness of Yao Ming's game play). Suppose for example that the TM module 78 analyzed data of tags of another user and determined that this user preferred to utilize words such as, for example, “super”, and/or “excellent” when describing Yao Ming's performance. In this regard, when the TM module 78 determines that the user is making another comment(s) about the same topic (e.g., fondness of Yao Ming's game play), the TM module 78 may enable the display 85 to provide a suggested or recommended tag(s) (e.g., a word(s)) to the user for selection. In this regard, in response to receipt of an indication of a selection of the recommendation, the TM module 78 may include the selected word(s) recommendation (e.g., “excellent”) into a current comment (e.g., “I think Yao Ming's performance against the Mavericks™ was ‘excellent’”) being input by the user interface 67 of the apparatus 50.

In another example embodiment, the TM module 78 may identify users which utilize similar preferred words when commenting on a certain topic (e.g., the same determined topic). In this regard, the TM module 78 may inform the corresponding users about each other and may send a message to the apparatuses 50 of the users indicating that they are commenting about the same topic with similar words and asking them if they would like to become friends of a social network service (e.g., Facebook™, LinkedIn™, Twitter™, MySpace™, etc.). For example, presume that multiple users (e.g., at least two users) may utilize one or more similar words about the same topic to express their feelings about a certain thing. In this regard, the TM module 78 may generate a message to inform an apparatus 50 utilized by one of the users that there is another user using the same types of words about a particular a common topic (e.g., sports, food, etc.). For instance, consider an instance in which one user may utilize preferred words (e.g., “The food at Restaurant A in the arena where the Houston Rockets™ play was ‘delicious.’”) when utilizing the user interface 67 to include comments in a document(s) (e.g., content of a web page) about a topic related to food. Consider, for example, also that another user may utilize the same words or same type of words when commenting (e.g., “Restaurant A in the Toyota Center™, where the Houston Rockets™ play has the most ‘delicious’ steaks.”) about the same topic (e.g., food) within the document(s). In this regard, the TM module 78 may determine that the two users (e.g., user A and user B) are using the same preferred word(s) (e.g., “delicious”) about the same topic (e.g., food at the arena of the Houston Rockets™).

As such, the TM module 78 may send the apparatuses 50 of one or both users (e.g., user A and user B) a message indicating that they have similar feelings about the same thing (e.g., same topic (e.g., food)). The TM module 78 may send a message to the apparatuses 50 of the users recommending to the users that they connect to each other as friends. In response to receipt of an indication of a selection by one of the users (e.g., user A), indicating that he/she would like to be a friend of the other user (e.g., user B), the TM module 78 may send the apparatus 50 of the other user (e.g., user B) a message indicating the friend request. In response to the other user (e.g., user B) accepting the request, the TM module 78 may connect the two users as friends in a social network service (e.g., Facebook™, LinkedIn™, etc.)

In an alternative example embodiment, in response to receipt of an indication of the selection of the friends request, the TM module 78 may connect the two users as contacts in a contact list (e.g., a phone book) of their apparatuses 50. On the other hand, in an instance in which the other user rejects the friend request, the TM module 78 may send a message to the apparatus of the user (e.g., user A) desiring to be friends indicating that the friends request was rejected.

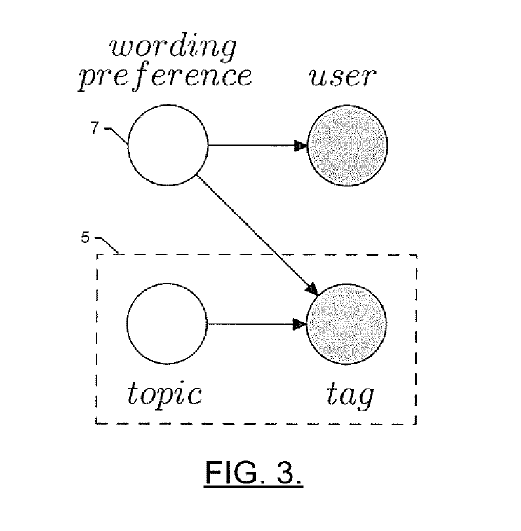

Referring now to FIG. 3, a schematic diagram of an illustration a graphical model for determining a wording preference of a user according to an example embodiment is provided. In the example embodiment of FIG. 3, the TM module 78 may determine that a user(s) has a certain wording preference(s) since each person may have a particular wording preference based on their culture, background, education, etc. In the example of FIG. 3, in response to analyzing data associated with a document(s), the TM module 78 may identify a topic of the document(s). Additionally, in the example embodiment of FIG. 3, the TM module 78 may determine a topic associated with a tag(s) (e.g., comments) provided or generated by the user. In the example of FIG. 3, the TM module 78 may analyze data associated with the tag(s) and may determine one or more word preferences of the user. The word preference of the user may be provided to the user for selection and/or inclusion in other comments/tags that may be generated by the user.

As an example of the manner in which the TM module 78 may generate the topic model and one or more suggested or recommended tags (e.g., preferred words) that may be included within one or more documents, consider the following. For purposes of illustration and not of limitation, consider that a document(s) in this example embodiment may relate to the content (e.g., web content) of one or more URLs. However, as described above, the document(s) may relate to an image(s), picture(s), photograph(s), video(s), file(s), etc. or any other information without departing from the spirit and scope of the invention. In this example embodiment, for each URL, in an instance in which the TM module 78 may determine that there are one or more users commenting on the content of the URL, the TM module 78 may generate one or more tags (e.g., preferred words) for inclusion in each URL.

The TM module 78 may generate the topic model to generate one or more tags of a document(s) (e.g., a URL(s)) in the following manner. For each URL, the TM module 78 may analyze data of the corresponding URL and may determine or generate a topic(s) of the URL. For example, in an instance in which the URL relates to http://www.nba.com/rockets/index_main.html, the TM module 78 may analyze the data of the URL and may determine that the topic corresponds to basketball. Additionally, the TM module 78 may analyze data of each URL (e.g., http://www.nba.com/rockets/index_main.html) to detect comments or tags generated by one or more users. For purposes of illustration and not of limitation, the comments/tags, detected by the TM module 78, associated with the http://www.nba.com/rockets/index_main.html URL may be “Yao Ming is an excellent basketball player”, “Yao Ming's jump shot is excellent” and/or “The food at Restaurant B in the arena of the Houston Rockets™ is delicious, I recommend it”. For each tag of the URL, the TM module 78 may generate a topic(s) of the corresponding comment(s)/tag(s). For instance, for the comment/tag, “Yao Ming is an excellent basketball player”, the TM module 78 may analyze the data of the tag and determine that a topic of this tag corresponds to “favorite basketball players”, for example. As another example, the TM module 78 may examine the data of the comment/tag “The food at Restaurant B in the arena of the Houston Rockets™ is delicious, I recommend it” and may determine that the corresponding topic relates to “restaurants”, for example.

The TM module 78 may generate the wording preference of a particular user. For instance, the TM module 78 may determine that a particular user's (e.g., user 1) word preference about the topic relating to favorite basketball players corresponds to the word preference “excellent” to describe their feelings about the basketball player. The TM module 78 may determine that the user's word preference for describing the user's preference about their favorite basketball player by analyzing the data of the comments/tags “Yao Ming is an excellent basketball player”, “Yao Ming's jump shot is excellent” in which the user utilized the word “excellent” to describe Yao Ming. On the other hand, the TM module 78 may determine that another user's (e.g., user 2) word preference(s) about the topic relating to favorite basketball players corresponds to the word preference “terrific”, for example, to describe their feelings about the basketball player (e.g., Yao Ming). The TM module 78 may determine that this other user's (e.g., user 2) word preference(s) for describing the user's preference about their favorite basketball player by analyzing the other comments/tags such as, for example, “Yao Ming is a ‘terrific’ post player” and/or “Yao Ming's bank shot is ‘terrific’” in which the user utilized the preferred word “terrific” to describe Yao Ming's performance.

Additionally, the TM module 78 may generate one or more tags according to the determined topic(s) and the determined word preference(s). For purposes of illustration and not of limitation, the TM module 78 may generate a recommended tag(s) (e.g., the suggested or recommended word “excellent”) based on the determined topic such as, for example, “favorite basketball player” and the determined word preference(s), such as, for example, “excellent”. As such, in an instance in which the TM module 78 may determine that a user (e.g., user 1) of an apparatus 50 is utilizing the user interface 67 to generate a comment(s)/tag(s) to be included within a document and that the comment(s) relates to the topic “favorite basketball players”, the TM module 78 may suggest/recommend a tag such as, for example, preferred word “excellent” to the user for selection and inclusion in the comment(s).

The TM module 78 may enable the display 85 to indicate/show to the user the recommended tag (e.g., preferred word “excellent”) for inclusion in the comments. As an example, consider an instance in which the user may utilize the user input interface 67 to include a comment(s) such as, for example, “Yao Ming played . . . ”. In this regard, as the user may be utilizing the user interface 67 to type the sentence “Yao Ming played . . . ”, the TM module 78 may provide the recommended tag(s) (e.g., suggested/preferred word “excellent”) for selection and inclusion in the sentence. In this regard, in response to an indication of a selection of the recommended tag(s), the TM module 78 may include the recommended tag(s) in the sentence such that the sentence may indicate “Yao Ming played ‘excellent’ in the All Star Game”, for example.

It should be pointed out that the TM module 78 may determine which user is utilizing certain word preferences based on data associated with a training model. For example, by utilizing data associated with the training model, the TM module 78 may determine which user may be utilizing a particular kind or type of word preference. As such, the TM module 78 may identify a user(s) as utilizing a particular word preference(s) based on the data corresponding to one or more tags/comments generated by the corresponding user when compared to data of the training model. For purposes of illustration and not of limitation, the training model utilized by the TM module 78 may be developed, for example, such that in response to detection of data associated with a tag(s)/comment(s) of a user spelling out the full name of a restaurant (e.g., Kentucky Fried Chicken™) that this data corresponds to a particular user (e.g., user A). On the other hand, in an instance in which the data of a tag(s) or comments of a user indicates that a name of a restaurant is abbreviated (e.g., KFC™) for example, the data of the training model utilized by the TM module 78 may indicate that this tag(s) or comments may relate to a different user (e.g., user B), for example.

Additionally or alternatively, in one example embodiment, in addition to the TM module 78 determining one or more word preferences of one or more users, the TM module 78 may also determine a grammar preference of one or more users. For purposes of illustration and not of limitation, consider an example in which a novel or manuscript may be written but the author may be unknown. In this example, the novel/manuscript may be written with very good grammar. Also, in this example, presume that a grammar training model is trained with grammar used by Shakespeare's masterpiece Hamlet™. The TM module 78 may analyze the data of the novel/manuscript and may determine that the grammar is very similar to the grammar utilized by Shakespeare. As such, the TM module 78 may determine that the novel/manuscript is written by Shakespeare because the grammar is very similar to the grammar and the word selection of the novel/manuscript utilized in the grammar training model which relates to Shakespeare's Hamlet in this example.

The TM module 78 may implement the topic model of an example embodiment as described below. Given a set of documents (e.g., URLs) D={1, 2, . . . M}, for d-th document (e.g., URL), there may be a set of tags Wd={wd1, . . . , wdNd}. Tag wij may be tagged by a user denoted as user uij$, for example. In one example embodiment, a task of the TM module 78 may be to mine latent topics using both documents (e.g., URLs) and their determined tag(s). Ideally, if all users would use the same words for a specific topic, all tags should be unbiased and used for topic mining of the documents (e.g., URLs). In this case, tags may be assumed to be generated directly from topics as shown by the dashed box 5 of FIG. 3.

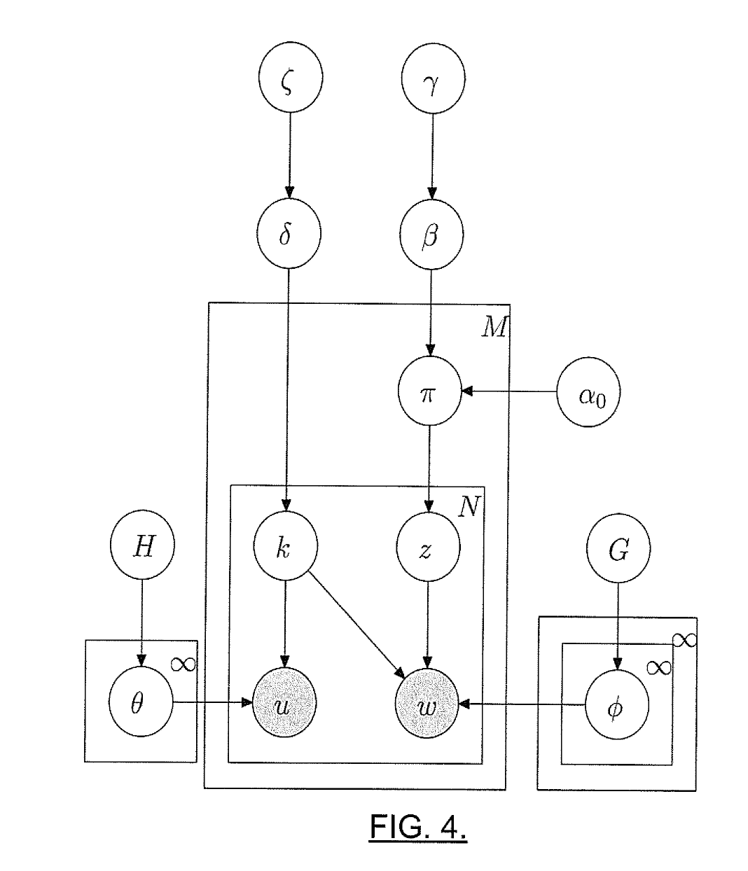

However, in reality, a wording preference(s) of different users are typically different even when different users talk about a same topic. In view of the notion that tags are generally labeled by different users, the TM module 78 may understand that tags are generated through different kinds of wording preferences 7, as shown in FIG. 3. By analyzing data associated with tags and word preferences in the manner described above, the TM module 78 may generate a topic model with wording preferences on tags, as shown by the graphical topic model of FIG. 4. For instance, in the graphical topic model of FIG. 4, the TM module 78 may determine that each document (e.g., URL) has a mixture of underlying topics modeled by a Hierarchical Dirichlet Process (HDP), utilizing determined wording preferences of different users modeled by a Dirichlet Process (DP).

The generative process underlying the topic model implemented by the TM module 78 may be generated as follows:

For each kind of wording preference {1, . . . , ∞}, the TM module 78 may (1) generate Φₖ|G˜G. Additionally, the TM module 78 may (2) generate θ|H˜H and may (3) generate β|γ˜GEM(γ) Additionally, for each document (e.g., URL) dε{1, . . . , M}), the TM module 78 may (a) generate topic proportion π_{d}|α₀, β˜DP(α₀, β). For each tag iε{1, . . . , N_{d}}, the TM module 78 may generate: (a) preference proportion δ_{di}={δ₁, . . . , δ_{∞}}|ξ₀˜GEM(ξ₀); (b) the wording preference k_{di}|δ_{di}˜Discrete(δ_{di}); (c) the topic of tag z_{di}|π_{d}˜Discrete(π_{d}); (d) a tag w_{di}|z_{di}, (Φ_{di})_{z=1}^{∞}˜F₁(Φ_{z}_{_{—}}_{di,k}_{_{—}}_{di}); and (d) a user u_{di}|k_{di}, (θₖ)ₖ₌₁^{∞}˜F₂(θₖ_{_{—}}_{di}).

The TM module 78 may sample the likelihood parameter Φ={Φ1, . . . , Φ∞} and θ={θ1, . . . , θ∞} from the base distribution G and H, respectively. Where, for each preference of wording, Φk={Φk, 1, . . . , Φk, ∞} is used as the parameter of the likelihood function F1 which is the distribution of tags over topics, and θ is used as the parameter of the likelihood function F2 which is the distribution of users over the wording preference.

Subsequently, the TM module 78 may generate the global vector of mixing proportions β={β1, . . . , β∞} with stick-breaking construction GEM(·) with parameter γ. As referred to herein, GEM may denote a stick-breaking construction named by Ewens (1990) on behalf of authors of the stick-breaking construction such as, for example, Griths, Engen and McCloskey. For each document (e.g., URL) d, the TM module 78 may first generate the topic proportion π={πd, 1, . . . , πd, ∞}. And for each tag i of this document (e.g., URL), the TM module 78 may need to generate the topic of this corresponding tag and the wording preference of the user generating this tag. The topic of this tag zdi may be determined, via the TM module 78, by topic proportion ad of this corresponding document (e.g., URL). However, the generation of the tag wdi may also need the wording preference kdi of the user udi. In addition, this preference kdi may be sampled by the TM module 78 from preference proportion δdi, which may also be determined by a stick-breaking construction GEM(·). As the preference of wording may relate to the character of users, it may only be related to the user and may have nothing to do with the document (e.g., URL). Next, the TM module 78 may need to collect enough information to generate the tag by the likelihood function F1(·) using the parameter φz,k with the indicator zdi and kdi. Meanwhile, the user udi providing or generating this tag may also be obtained by the likelihood function F2(·) using the parameter θk with the indicator kdi.

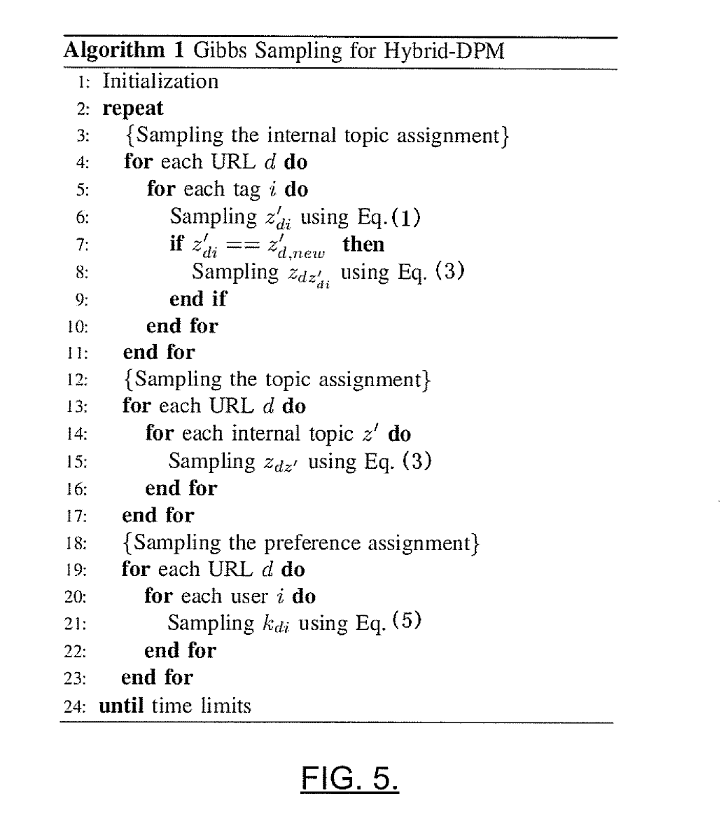

In one example embodiment, the TM module 78 may utilize a Gibbs sampling to inference a topic model as set forth in the table of FIG. 5 and as provided by the equations set forth below utilized by the TM module 78.

$$\begin{matrix}P ( {z}_{di}^{′} = {z}^{′} \vert {z}_{- di}^{′} , {w}_{di} , φ ) ∝ \frac{{n}_{{dz}^{′} \cdot }^{- di}}{{n}_{d \cdot \cdot }^{- di} + γ} {f}_{1 {z}_{{dz}^{′}} , {k}_{di}} ( {w}_{di} ) \\ p ( {z}_{di}^{′} = {z}_{new}^{′} \vert {z}_{- di}^{′} , {w}_{di} , φ ) ∝ \frac{γ}{{n}_{d \cdot \cdot }^{- di} + γ} {f}_{1 {z}_{{dz}_{new}^{′}}} , {k}_{di} ( {w}_{di} ) & ( 1 ) \\ {f}_{1 z , {k}_{di}}^{- {w}_{di}} ( {w}_{di} \vert φ ) = \frac{\int {f}_{1} ( {w}_{di} \vert {φ}_{z , {k}_{di}} ) {\prod }_{{{d}^{′} {i}^{′} \neq di}_{{z}_{{d}^{′} {i}^{′}} = z}} {f}_{1} ( {w}_{{d}^{′} {i}^{′}} \vert {φ}_{z , {k}_{di}} ) g ( {φ}_{z , {k}_{di}} ) d {φ}_{z , {k}_{di}}}{\int {\prod }_{{{d}^{′} {i}^{′} \neq di}_{{z}_{{d}^{′} {i}^{′} = z}}} {f}_{1} ( {w}_{{d}^{′} {i}^{′}} \vert {φ}_{z , {k}_{di}} ) g ( {φ}_{z , {k}_{di}} ) d {φ}_{z , {k}_{di}}} & ( 2 ) \\ P ( {z}_{{dz}^{′}} = z \vert {z}_{- {dz}^{′}} , {z}_{di}^{′} , φ ) ∝ \frac{{m}_{\cdot z}^{- {z}^{′}}}{{m}_{\cdot \cdot }^{- {z}^{′}} + {α}_{0}} {f}_{1 z}^{- {w}_{{dz}^{′}}} ( {w}_{{dz}^{′}} ) \\ P ( {z}_{{dz}^{′}} = {z}_{new} \vert {z}_{- {dz}^{′} ,} {z}_{di}^{′} , φ ) ∝ \frac{{α}_{0}}{{m}_{\cdot \cdot }^{- {z}^{′}} + {α}_{0}} {f}_{1 {z}_{new}}^{- {w}_{{dz}^{′}}} ( {w}_{{dz}^{′}} ) & ( 3 ) \\ {f}_{1 z}^{- {w}_{{dz}^{′}}} ( {w}_{{dz}^{′}} ) = {\prod }_{i : {z}_{di}^{′} = {z}^{′}} {f}_{1 z , {k}_{di}}^{- {w}_{{dz}^{′}}} ( {w}_{di} ) & ( 4 ) \\ P ( {k}_{di} = k \vert {k}_{- di} , {u}_{di} , θ ) ∝ \frac{{l}_{\cdot k \cdot }^{- di}}{{l}_{…} + ζ} {f}_{1 {z}_{di} , k} ( {w}_{di} ) {f}_{2 k} ( {u}_{di} ) \\ P ( {k}_{di} = {k}_{new} \vert {k}_{- di} , {u}_{di} , θ ) ∝ \frac{ζ}{{l}_{…} + ζ} {f}_{1 {z}_{di} , {k}_{new}} ( {w}_{di} ) {f}_{2 {k}_{new}} ( {u}_{di} ) & ( 5 ) \\ {f}_{2 k}^{- {u}_{di}} ( {u}_{di} \vert θ ) = \frac{\int {f}_{2} ( {u}_{di} \vert {θ}_{k} ) {\prod }_{{{d}^{′} {i}^{′} \neq di}_{{k}_{{d}^{′} {i}^{′} = k}}} {f}_{2} ( {u}_{{d}^{′} {i}^{′}} \vert {θ}_{k} ) h ( {θ}_{k} ) d {θ}_{k}}{\int {\prod }_{{{d}^{′} {i}^{′} \neq di}_{{k}_{{d}^{′} {i}^{′} = k}}} {f}_{2} ( {u}_{{d}^{′} {i}^{′} \vert {θ}_{k}} ) h ( {θ}_{k} ) d {θ}_{k}} & ( 6 )\end{matrix}$$

In an example embodiment, the TM module 78 may reduce a perplexity which may correspond in part to a matrix that measures a prediction capability. In an instance in which the value of the perplexity is low, the TM module 78 may make a prediction with more accuracy. On the other hand, when TM module 78 determines that a value associated with the perplexity is high, the TM module 78 may make a prediction with less accuracy. It should be pointed out that in one example embodiment, the TM module 78 may remove comments/tags of a document for consideration by the TM module 78 in an instance in which the TM module 78 may determine that the number of tags of the document are below a predetermined threshold (e.g., less than 10 tags within a document(s)). As referred to herein, removing the comments/tags of a document when a number of comments/tags are below the predetermined threshold may denote that the TM module 78 may not provide a word preference suggestion to a device (e.g., an apparatus 50) of a user (e.g., an author of the comments/tags) associated with generating the tags/comments. By not providing wording preference suggestions for tags within a document that are less than a predetermined threshold, the TM module 78 may minimize the impact of wasting resources (e.g., processing resources, memory resources, etc.) due in part to the difficulty in predictability related to determining word preferences of users in instances in which there may be small sample sizes of comments/tags within the document(s). In other words, a smaller sample size may result in a high perplexity indicating a low accuracy in predictability of determining wording preferences by the TM module 78.

By utilizing the TM module 78 to implement a topic model according to an example embodiment of the invention, the clustering results of the topic model may be improved. For instance, an experiment may be performed on a database storing multiple URLs and associated web content (e.g., a Del.icio.us™ database (also referred to herein as Delicious™ database). The TM module 78 may analyze data associated with each of the URLs of the database and may determine how many users have written comments/tags for the same URL. In an instance in which the TM module 78 may determine that the number of users who have written comments/tags is less than a predetermined threshold (e.g., less than 10), the TM module 78, in one embodiment, may remove this corresponding URL, and the comments/tags associated with this URL, from the database. In this example, the TM module 78 may utilize the remaining URLs and associated comments/tags of each of the URLs in the database for training the topic model of an example embodiment of the invention.

In this example, presume that the TM module 78 may determine that after removing the URLs having comments/tags below the predetermined threshold that the TM module 78 may determine that there is data indicating 221 URLs and associated comments/tags that may be written by 199 users associated with the remaining URLs in the database. As such, the data indicating the 221 URLs and 199 users may be utilized by the TM module 78 to training a topic model of an example embodiment. By removing the URLs and corresponding comments/tags that are below a predetermined threshold, the TM module 78 may remove noisy/useless data and the TM module 78 may determine that the average perplexity of predicting tags associated with URLs within the database may be reduced from 221.51 to 135.40 with a 10-fold cross validation, for example. In addition, the TM module 78 may provide a distribution of tags over the topics of each determined wording preference and this data may be used by the TM module 78 to recommend personalized tags (e.g., suggested or recommended words) to devices (e.g., apparatuses 50) users generating comments/tags associated with new URLs, for example.

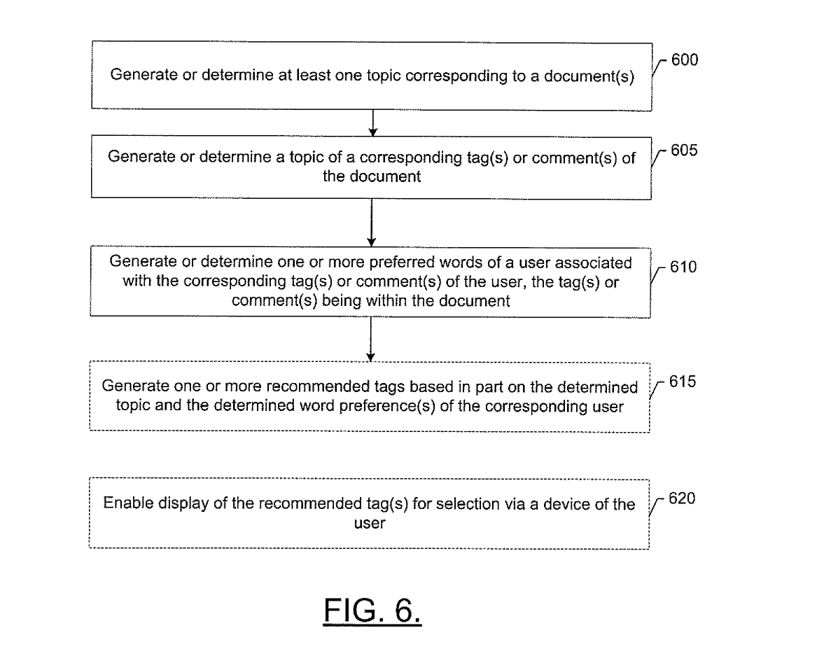

Referring to FIG. 6, an example embodiment of a flowchart for generating one or more word preferences of a user for selection is provided. At operation 600, an apparatus (e.g., TM module 78) may generate or determine at least one topic (e.g., basketball) for a document(s) (e.g., a URL(s), photograph(s), picture(s), etc.). In an example embodiment, an apparatus (e.g., TM module 78) may determine the topic based on analyzing information associated with the document. The information may, but need not, be based on data (e.g., semantic information) describing or indicating what the document is about. For example, in an instance in which the document may relate to a URL, for example, the data may, but need not, correspond to the text of the URL.

At operation 605, an apparatus (e.g., TM module 78) may, for each comment or tag of the document(s), generate or determine a topic (e.g., a favorite basketball player) of a corresponding tag/comment (e.g., “Yao Ming's performance was excellent”). At operation 610, an apparatus (e.g., TM module 78) may, for each comment or tag of the document(s), generate or determine one or more preferred words of a user. The apparatus (e.g., TM module 78) may determine the one or more preferred words (e.g., “excellent”) of the user based in part on analyzing data of a tag(s)/comment(s) (e.g., “Yao Ming is an excellent defensive player”) generated by the user within the document(s). At operation 615, an apparatus (e.g., TM module 78) may generate one or more recommended tags (e.g., semantic tags) (e.g., a suggested or recommended word(s)) based in part on a determined topic(s) (e.g., a favorite basketball player) and a determined word preference(s) (e.g., “excellent”) of a corresponding user. The determined word preference may relate to the topic associated with the comment(s)/tag(s) of the user. Optionally, at operation 620, an apparatus (e.g., TM module 78) may enable a display (e.g., display 85) to show the recommend tag(s) for selection via a device (e.g., apparatus 50) of the user.

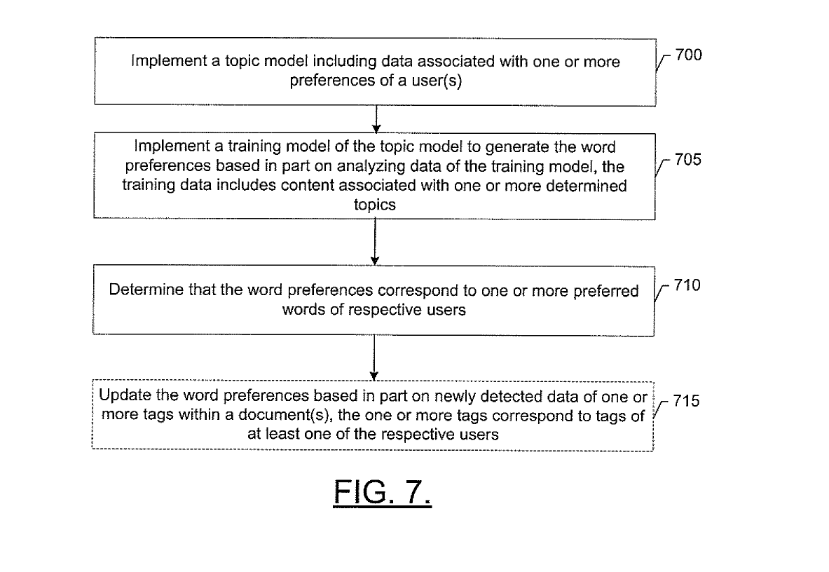

Referring to FIG. 7, an example embodiment of a flowchart for generating one or more word preferences of one or more users is provided. At operation 700, an apparatus (e.g., TM module 78) may implement a topic model including data associated with one or more word preferences of at least one user. At operation 705, an apparatus (e.g., TM module 78) may implement a training model of the topic model to generate the word preferences based in part on analyzing training data of the training model (also referred to herein as training procedure). The training data may include content associated with one or more determined topics (e.g., sports, restaurants, etc.). The training data may also include any other suitable information. At operation 710, an apparatus (e.g., TM module 78) may determine that the word preferences correspond to one or more preferred words of respective users. Optionally, at operation 715, an apparatus (e.g., TM module 78) may update the word preferences based in part on newly detected data of one or more tags within a document(s). The tags may correspond to tags of at least one of the respective users.

It should be pointed out that FIGS. 6 and 7 are flowcharts of a system, method and computer program product according to an example embodiment of the invention. It will be understood that each block of the flowcharts, and combinations of blocks in the flowcharts, may be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., processor 70, TM module 78). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIG. 6 and FIG. 7 above may comprise a processor (e.g., the processor 70, the TM module 78) configured to perform some or each of the operations (600-620, 700-715) described above. The processor may, for example, be configured to perform the operations (600-620, 700-715) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-620, 700-715) may comprise, for example, the processor 70 (e.g., as means for performing any of the operations described above), the TM module 78 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-26. (canceled)

27. A method comprising,
implementing a topic model comprising data associated with one or more word preferences of at least one user;
implementing a training model of the topic model to generate the word preferences based in part on analyzing training data of the training model, the training data comprising content associated with one or more determined topics; and
determining that the word preferences correspond to one or more preferred words of respective users.

28. The method of claim 27, further comprising:
updating the word preferences based in part on newly detected data of one or more tags within at least one document, the one or more tags correspond to tags of at least one of the respective users.

29. The method of claim 28, wherein updating comprises adding one or more additional preferred words to the wording preferences of the topic model in response to the newly detected data of the tags.

30. The method of claim 28, further comprising:
generating one or more profiles associated with the respective users in which the profiles comprise data indicating at least one preferred word of a corresponding user, the at least one preferred word is associated with at least one of the determined topics; and
utilizing the data of at least one of the profiles to determine that a respective user prefers to utilize at least one word, as opposed to another word, for a corresponding determined topic.

31. The method of claim 27, further comprising:
determining that at least one topic of the determined topics is associated with at least one document;
determining a first topic associated with data corresponding to at least one tag, the tag associated with one or more items of data of a user;
determining at least one preferred word of the user based in part on analyzing data of the tag; and
generating at least one recommended tag based in part on the determined first topic and the preferred word.

32. The method of claim 31, wherein the data of the tag corresponds to at least one comment of the user and the preferred word corresponds to at least one word preference of the user based on analyzing data in the comment.

33. The method of claim 31, wherein the recommended tag corresponds to the preferred word and wherein the method further comprises:
enabling display of the recommended tag for selection.

34. The method of claim 31, further comprising:
including the preferred word in a first tag within the document in response to receipt of an indication of the selection.

35. The method of claim 34, wherein including the preferred word further comprises including the preferred word in the first tag in response to determining that data of the first tag relates to the first topic.

36. The method of claim 34, further comprising at least one of:
determining one or more different preferred words relating to a word preference of another user based in part on analyzing data of one or more additional tags within the document, and
including at least one of the additional preferred words in at least a second tag associated with the another user in response to receipt of an indication of a selection of the additional preferred word, the data of the second tag corresponds to the first topic.

37. The method of claim 31, further comprising:
determining the identity of the user based in part on the preferred word corresponding to at least one word associated with the training model.

38. The method of claim 31, wherein the document comprises at least one of a Uniform Resource Locator, an image, a video, a photograph or a file.

39. An apparatus comprising:
at least one processor; and
at least one memory including computer program code, the at least one memory and the computer program code configured to, with the at least one processor, cause the apparatus to perform at least the following:
implement a topic model comprising data associated with one or more word preferences of at least one user;
implement a training model of the topic model to generate the word preferences based in part on analyzing training data of the training model, the training data comprising content associated with one or more determined topics; and
determine that the word preferences correspond to one or more preferred words of respective users.

40. The apparatus of claim 39, wherein the memory and computer program code are configured to, with the processor, cause the apparatus to:
update the word preferences based in part on newly detected data of one or more tags within at least one document, the one or more tags correspond to tags of at least one of the respective users.

41. The apparatus of claim 40, wherein the memory and computer program code are configured to, with the processor, cause the apparatus to:
update the word preferences by adding one or more additional preferred words to the wording preferences of the topic model in response to the newly detected data of the tags.

42. The apparatus of claim 40, wherein the memory and computer program code are configured to, with the processor, cause the apparatus to:
generate one or more profiles associated with the respective users in which the profiles comprise data indicating at least one preferred word of a corresponding user, the at least one preferred word is associated with at least one of the determined topics; and
utilize the data of at least one of the profiles to determine that a respective user prefers to utilize at least one word, as opposed to another word, for a corresponding determined topic.

43. The apparatus of claim 39, wherein the memory and computer program code are configured to, with the processor, cause the apparatus to
determine that at least one of the determined topics is associated with at least one document;
determine a first topic associated with data corresponding to at least one tag, the tag associated with one or more items of data of a user;
determine at least one preferred word of the user based in part on analyzing data of the tag; and
generate at least one recommended tag based in part on the determined first topic and the preferred word.

44. The apparatus of claim 43, wherein the data of the tag corresponds to at least one comment of the user and the preferred word corresponds to at least one word preference of the user based on analyzing data in the comment.

45. The apparatus of claim 43, wherein the recommended tag corresponds to the preferred word and wherein the memory and computer program code are further configured to, with the processor, cause the apparatus to:
enable display of the recommended tag for selection.

46. The apparatus of claim 43, wherein the memory and computer program code are configured to, with the processor, cause the apparatus to:
include the preferred word in a first tag within the document in response to receipt of an indication of the selection.

47. The apparatus of claim 46, wherein the memory and computer program code are configured to, with the processor, cause the apparatus to:
include the preferred word by including the preferred word in the first tag in response to determining that data of the first tag relates to the first topic.

48. The apparatus of claim 46, wherein the memory and computer program code are configured to, with the processor, cause the apparatus to at least one of:
determine one or more different preferred words relating to a word preference of another user based in part on analyzing data of one or more additional tags within the document, and
include at least one of the additional preferred words in at least a second tag associated with the another user in response to receipt of an indication of a selection of the additional preferred word, the data of the second tag corresponds to the first topic.

49. The apparatus of claim 43, wherein the memory and computer program code are configured to, with the processor, cause the apparatus to:
determine the identity of the user based in part on the preferred word corresponding to at least one word associated with the training model.

50. The apparatus of claim 43, wherein the document comprises at least one of a Uniform Resource Locator, an image, a video, a photograph or a file.
